(19) United States
(12) Patent Application Publication
(10) Pub. No.: US 2026/0257412 A1
(43) Pub. Date: Sep. 3, 2026

(54) Stiffener Manufacturing Device and Stiffener Manufacturing Method Using Same

(71) Applicant: LOTTE CHEMICAL CORPORATION, Seoul (KR)

(72) Inventor: Ho Gun JEONG, Uiwang-si (KR)

(21) Appl. No.: 18/879,891

(22) PCT Filed: Jun. 27, 2023
(86) PCT No.: PCT/KR2023/008919

§ 371 Date: Dec. 30, 2024

(30) Foreign Application Priority Data
Jun. 30, 2022 (KR) 10-2022-0080398

(51) Int. Cl. B29C 48/15; B29C 48/00; B29C 48/09; B29C 48/88; B29C 70/16; B29L 31/30

(52) U.S. Cl. CPC B29C 48/15; B29C 48/0022; B29C 48/09; B29C 48/9115; B29C 70/16; B29L 2031/3044

(57) ABSTRACT

The present invention provides a stiffener manufacturing device comprising: an unwinder unit for unwinding a continuous fiber reinforced composite material (CFT) to continuously supply same; an extrusion unit provided at one side of the unwinder unit, including a first flow path through which the continuous fiber reinforced composite material flows, and a second flow path through which a long fiber composite material (LFT) is introduced at an angle different from the angle at which the continuous fiber reinforced composite material is introduced, and including a mold for laminating the long fiber composite material to the outside of the continuous fiber reinforced composite material; a sizing unit for cooling a molded product discharged from the extrusion unit.

### TECHNICAL FIELD

The present invention relates to a stiffener manufacturing device and a stiffener manufacturing method using the same. More particularly, the present invention relates to a device for manufacturing a hollow stiffener provided with a curvature through an extrusion process, and a stiffener manufacturing method using the same.

### BACKGROUND ART

Recent stricter automotive safety regulations mandate installation of a stiffener for pedestrian protection at a lower end of a bumper beam of an automobile. The stiffener is mounted at the lower end of the automotive bumper beam to minimize pedestrian injuries in low-speed collisions by absorbing shock. To function as a shock absorber upon collision with a bumper, the stiffener is required to have a curvature that conforms to the shape of the bumper.

Given that such stiffeners are safety components that require good impact resistance, steel products in the form of round bars or plastic molded products manufactured through GMT press processes or injection molding processes are commonly used as the stiffeners.

However, steel stiffeners in the form of round bars and plastic stiffeners manufactured through GMT press processes have drawbacks such as high labor costs, difficulty in achieving a constant curvature, and incompatibility with the trend towards lightweight automotive designs. Therefore, there is an urgent need for a stiffener manufacturing device capable of manufacturing a stiffener for vehicles that is easy to manufacture by extrusion, is lightweight, has enhanced strength and rigidity, and is provided with a constant curvature.

As the background technique of the present invention, a lower stiffener device for vehicles is disclosed in Korean Patent Laid-open Publication No. 10-2021-0062213.

### DISCLOSURE

### Technical Problem

It is one object of the present invention to provide a stiffener manufacturing device capable of manufacturing a hollow stiffener for vehicles including a continuous fiber-reinforced thermoplastic through an extrusion process.

It is another object of the present invention to provide a stiffener manufacturing method using the stiffener manufacturing device, which can prevent interfacial debonding between a long fiber-reinforced thermoplastic and a continuous fiber-reinforced thermoplastic inserted into the long fiber-reinforced thermoplastic and can enhance the strength and stiffness of a hollow stiffener by placing the continuous fiber-reinforced thermoplastic at a specific location in the hollow stiffener.

The above and other objects of the present invention will become apparent from the detailed description of the following embodiments.

### Technical Solution

1. One aspect of the present invention relates to a stiffener manufacturing device.

The stiffener manufacturing device includes: an unwinder unwinding and continuously supplying a continuous fiber-reinforced thermoplastic (CFT);
an extrusion unit disposed at one side of the unwinder and comprising a mold in which a long fiber-reinforced thermoplastic (LFT) is bonded to an outer circumference of the continuous fiber-reinforced thermoplastic, the mold including a first flow channel into which the continuous fiber-reinforced thermoplastic is introduced and a second flow channel into which the long fiber-reinforced thermoplastic is introduced at a different angle than the continuous fiber-reinforced thermoplastic;
a sizing unit cooling a molded product discharged from the extrusion unit;
a first puller disposed downstream of the sizing unit and adjusting tension of the continuous fiber-reinforced thermoplastic;
a curvature forming unit imparting a predetermined curvature to the molded product while cooling the molded product;
a second puller pulling the molded product provided with the curvature; and
a cutting unit disposed downstream of the second puller to cut the molded product provided with the curvature.

2. In embodiment 1, the second flow channel is tilted at an angle of 30° to 65° with respect to an extension direction of the first flow channel.

3. In embodiment 1 or 2, the first flow channel may include a flow check gate tapered at one end thereof.

4. In any one of embodiments 1 to 3, the first flow channel may be provided on an outer circumference thereof with a first coolant line.

5. In any one of embodiments 1 to 4, the mold may further include a core at which the first flow channel is joined with the second channel and in which the long fiber-reinforced thermoplastic is continuously introduced to the outer circumference of the continuous fiber-reinforced thermoplastic to form the molded product.

6. In embodiment 5, an insert securing portion may be disposed downstream of the core.

7. In embodiment 5 or 6, the insert securing portion may be provided on an outer circumference thereof with a second coolant surrounding the insert securing portion.

8. In any one of embodiments 1 to 7, the sizing unit may include a third coolant line cooling the molded product and a vacuum pump disposed at one side thereof.

9. In any one of embodiments 1 to 8, the continuous fiber-reinforced thermoplastic may comprise at least two prepregs.

10. In any one of embodiments 1 to 9, the unwinder may adjust tension of each prepreg introduced into the mold.

11. In any one of embodiments 1 to 10, the curvature forming unit may include one or more curvature forming devices arranged continuously to adjust the curvature of the molded product transferred from the first puller.

12. Another aspect of the present invention relates to a stiffener manufacturing method.

The stiffener manufacturing method includes: (a) unwinding a continuous fiber-reinforced thermoplastic in the form of two or more prepregs while adjusting tension of each of the prepregs;
(b) introducing the continuous fiber-reinforced thermoplastic into a first flow channel of a mold while introducing a long fiber-reinforced thermoplastic into a second flow channel of the mold, the second flow channel being formed at a different angle than the first flow channel, the first flow channel being provided at one end thereof with a flow check gate to prevent backflow of the continuous fiber-reinforced thermoplastic;
(c) introducing the long fiber-reinforced thermoplastic in a heated state into a core of the mold to bond the long fiber-reinforced thermoplastic to an outer circumference of the continuous fiber-reinforced thermoplastic;
(d) forming a molded product by securing the continuous fiber-reinforced thermoplastic in position at an insert securing portion disposed downstream of the core, followed by extrusion of the continuous fiber-reinforced thermoplastic together with the introduced long fiber-reinforced thermoplastic;
(e) sizing the molded product formed by extrusion under pressure while cooling the molded product;
(f) manufacturing a hollow stiffener by imparting a predetermined curvature to the molded product cooled in the step of sizing the molded product; and
(g) recovering the stiffener by cutting the molded product provided with the curvature.

13. A further aspect of the present invention relates to a hollow stiffener for vehicles manufactured by the stiffener manufacturing method according to embodiment 12.

### Advantageous Effects

The stiffener manufacturing device according to the present invention can manufacture a hollow extruded stiffener including a continuous fiber-reinforced thermoplastic (CFT) as a reinforcing insert. The stiffener manufacturing device can continuously produce a stiffener for vehicles in an effective manner using a continuous fiber in the form of a prepreg impregnated with a matrix as a reinforcing material by preventing backflow or stagnation of the continuous fiber-reinforced thermoplastic through adjustment of the angle of a second flow channel for passage of a long fiber-reinforce thermoplastic (LFT) used together with the continuous fiber-reinforced thermoplastic to form a molded product, cooling conditions, and tension of the continuous fiber-reinforced thermoplastic and imparting a curvature to the molded product.

Static load performance of the manufactured stiffener may be increased by 16% or more at a displacement of 30 mm and by 14% or more at a displacement of 40 mm, as measured in a static load test using a UTM, compared to that of a stiffener without the reinforcing material.

### DESCRIPTION OF DRAWINGS

FIG. 1 is a plan view of a stiffener manufacturing device according to one embodiment of the present invention.

FIG. 2 is a side sectional view of a mold of an extrusion unit of the stiffener manufacturing device according to one embodiment of the present invention.

FIG. 3 is a flowchart of a stiffener manufacturing method using the stiffener manufacturing device according to another aspect of the present invention.

FIG. 4 shows results of a structural analysis simulation of static load performance of a stiffener with varying placement of a continuous fiber-reinforced thermoplastic within the stiffener.

FIG. 5 shows results of a structural analysis simulation of static load performance of a stiffener according to one embodiment of the present invention with varying placement of a continuous fiber-reinforced thermoplastic within the stiffener and results of measuring static load performance of a stiffener manufactured by placing the continuous fiber-reinforced thermoplastic at corresponding locations.

FIG. 6 is a photograph of a stiffener manufactured by the stiffener manufacturing method according to one embodiment of the present invention.

### BEST MODE

Hereinafter, exemplary embodiments of the present invention will be described in detail with reference to the accompanying drawings. It will be understood that the accompanying drawings are provided only to aid in understanding of the embodiments disclosed herein and the technical spirit disclosed in the specification is not limited by the accompanying drawings. In addition, the shape, size, scale, angle, and number of each element illustrated in the drawings are exemplary and thus should not be construed as limiting the scope of the present invention.

It should be noted that like components will be denoted by like reference numerals throughout the specification and the accompanying drawings. In addition, description of known functions and constructions which may unnecessarily obscure the subject matter of the present invention will be omitted.

As used herein, the terms “includes,” “comprises,” “including,” and/or “comprising” specify the presence of stated features, steps, operations, elements, and/or components, but do not preclude the presence or addition of one or more other features, steps, operations, elements, components, and/or groups unless such terms are preceded by “only”. As used herein, the singular forms “a,” “an,” and “the” are intended to include the plural forms as well, unless the context clearly indicates otherwise.

A numerical value related to a certain component is construed to include a tolerance range in interpretation of components, unless clearly stated otherwise.

It will be understood that, when an element is referred to as being located “on,” “above,” below,” or “beside” another element, one or more intervening elements may be present between the two elements unless such terms are preceded by “directly”.

Spatially relative terms, such as “upper portion,” “upper surface,” “lower portion,” “lower surface,” and the like, are defined with reference to the drawings and do not indicate absolute orientations. In other words, “upper portion (surface)” may be defined as “lower portion (surface)” and vice versa depending on the point of view.

As used herein to represent a specific numerical range, the expression “a to b” means “≥a and ≤b”.

Hereinafter, a stiffener manufacturing device according to one embodiment of the present invention will be described with reference to the accompanying drawings.

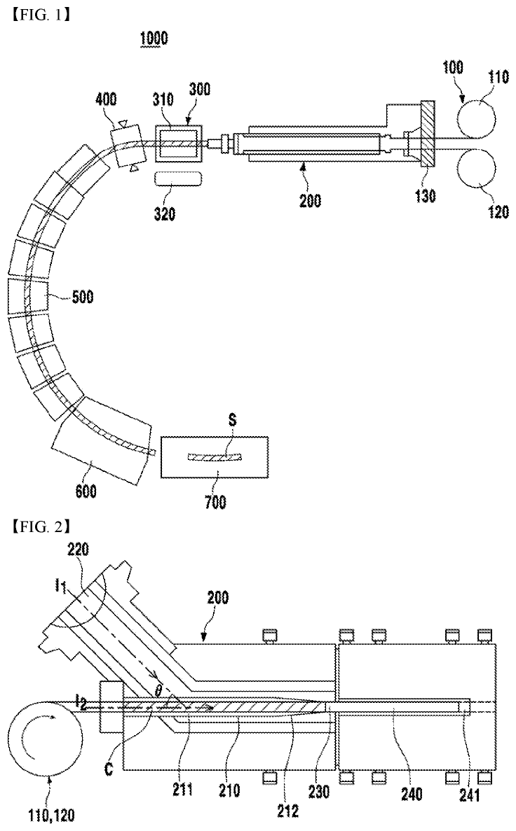

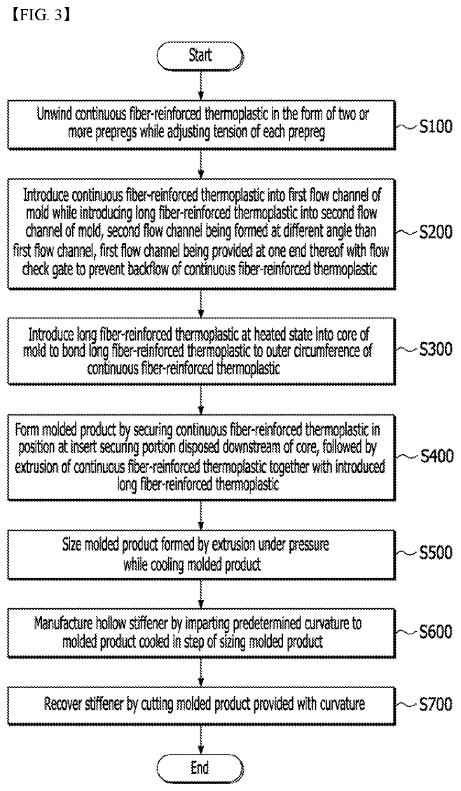

FIG. 1 is a plan view of a stiffener manufacturing device according to one embodiment of the present invention, and FIG. 2 is a side sectional view of a mold of an extrusion unit of the stiffener manufacturing device according to one embodiment of the present invention.

Referring to FIG. 1 and FIG. 2, the stiffener manufacturing device 1000 includes an unwinder 100, an extrusion unit 200, a sizing unit 300, a first puller 400, a curvature forming unit 500, a second puller 600, and a cutting unit 700.

The unwinder 100 may unwind and continuously supply a continuous fiber-reinforced thermoplastic (CFT).

The unwinder 100 provides continuous supply of the continuous fiber-reinforced thermoplastic (CFT) wound thereon, may be disposed upstream of the extrusion unit 200 to continuously supply the continuous fiber-reinforced thermoplastic to the extrusion unit 200, and may include two or more bobbins 110, 120 in consideration of the reinforcement location and input amount of the continuous fiber-reinforced thermoplastic.

Through adjustment of the tension of each of the bobbins 110, 120, the unwinder 100 may adjust tension of each continuous fiber-reinforced thermoplastic introduced into the extrusion unit 200 independently.

When the continuous fiber-reinforced thermoplastic C is introduced into the extrusion unit 100 as two or more prepregs and a predetermined curvature is imparted to a molded product by the curvature forming unit 500, the tension applied to each continuous fiber reinforced-thermoplastic C can be different. For example, a continuous fiber-reinforced thermoplastic placed in a region with a larger curvature can be subjected to excessive tension, causing the corresponding continuous fiber-reinforced thermoplastic to be displaced from a designated position thereof within the molded product and exposed outside a stiffener.

Since the unwinder 100 can adjust the tension of each continuous fiber-reinforced thermoplastic C independently through adjustment of the rotational speed of each bobbin 110, 120, it is possible to effectively prevent the continuous fiber-reinforced thermoplastic C from being displaced from a designated position thereof within the molded product even when the curvature of a molded product is increased by the curvature forming unit 500.

The unwinder 100 may further include an aligner 130 at one side of each bobbin 110, 120 to guide the continuous fiber-reinforced thermoplastic C in a predetermined direction.

The extrusion unit 200 is disposed at one side of the unwinder 100.

The extrusion unit 200 may form a molded product by receiving the continuous fiber-reinforced thermoplastic C through one side thereof and introducing a long fiber-reinforced thermoplastic (LFT) to an outer circumference of the continuous fiber-reinforced thermoplastic C, followed by extrusion.

Specifically, the extrusion unit 200 includes a mold including a first flow channel 210 and a second flow channel 220, wherein the second flow channel 220 is disposed at a different angle than the first flow channel 210.

The continuous fiber-reinforced thermoplastic C is continuously introduced into the first flow channel 210, and the long fiber-reinforced thermoplastic is introduced into the second flow channel 220 at an angle different from that of the continuous fiber-reinforced thermoplastic to be bonded to the outer circumference of the continuous fiber-reinforced thermoplastic C and is extruded through the mold to form a hollow molded product, which, in turn, is transferred to the other side of the extrusion unit 200.

With the mold configured as described above, the extrusion unit 200 can continuously form an elongated hollow molded product (stiffener) by bonding the long fiber-reinforced thermoplastic to the continuous fiber-reinforced thermoplastic C, followed by extrusion.

The continuous fiber-reinforced thermoplastic C may be a composite material consisting of: a reinforcement phase including at least one selected from among glass fiber, carbon fiber, or aramid fiber; and a matrix phase including at least one resin selected from among polypropylene (PP), polyamide 6 (PA6), polyamide 66 (PA66), thermoplastic polyurethane (TPU), polyethylene terephthalate (PET), high-density polyethylene (HDPE), polyphenylene sulfide (PPS), and polyetheretherketone (PEEK).

For example, the continuous fiber-reinforced thermoplastic C may be a tape-shaped prepreg having a thickness of 10 mm or more, wherein a glass fiber roving is impregnated with a resin matrix. In this case, the continuous fiber-reinforced thermoplastic C can have increased interfacial adhesion to the long fiber-reinforced thermoplastic and thus can be effectively prevented from being displaced from a designated position thereof within the molded product.

Use of a continuous fiber-reinforced thermoplastic not impregnated with a resin can lead to poor interfacial adhesion between the continuous fiber-reinforced thermoplastic C and the long fiber-reinforced thermoplastic within the molded product.

Although it is difficult to reinforce a hollow molded product with a large amount of continuous fiber-reinforced thermoplastic C due to small cross-sectional area thereof, using a prepreg impregnated with a resin as the continuous fiber-reinforced thermoplastic C is advantageous for reinforcing the molded product with a larger amount of the continuous fiber-reinforced thermoplastic.

In one embodiment, the continuous fiber-reinforced thermoplastic C may comprise at least two prepregs.

When two or more prepregs are provided as the continuous fiber-reinforced thermoplastic C, it is possible to effectively increase the strength and stiffness of the molded product by placing the prepregs in regions subjected to impact loads in the event of collision, respectively.

Since the unwinder 100 unwinds the continuous fiber-reinforced thermoplastic C in prepreg form and feeds the continuous fiber-reinforced thermoplastic C into the first flow channel 210 of the extrusion unit 200 to secure the continuous fiber-reinforced thermoplastic C in position and the long fiber-reinforce thermoplastic is introduced into the extrusion unit in a way that does not increase the load on the continuous fiber-reinforced thermoplastic C to ensure adjustment of the tension applied to the continuous fiber-reinforced thermoplastic C, it is possible to manufacture a hollow molded product with significantly enhanced strength and stiffness.

The continuous fiber-reinforced thermoplastic C is introduced into the first flow channel 210, and the long fiber-reinforced thermoplastic is introduced into the second flow channel 220.

In one embodiment, the long fiber-reinforced thermoplastic may be fed in the form of pellets containing long fibers. More preferably, the long fiber-reinforced thermoplastic is plasticized at a temperature of 170° C. to 210° C. in a long fiber-reinforced thermoplastic supply unit (not shown) disposed at one side of the extrusion unit 200 before being introduced into the second flow channel 220.

The long fiber-reinforced thermoplastic is introduced into the extrusion unit 200 and is bonded to the continuous fiber-reinforced thermoplastic in the mold, followed by extrusion, thereby manufacturing a molded product.

Since the long fiber-reinforced thermoplastic has high stiffness and good injection moldability, the long fiber-reinforced thermoplastic can ensure increase in production speed when selected as a matrix for a molded product including the continuous fiber-reinforced thermoplastic C as a reinforcing material.

In one embodiment, an extension direction I1 of the second flow channel 220 may be tilted at an angle θ of 30° to 65° with an extension direction I2 of the first flow channel 210.

When the angle θ falls within this range, it is easy to adjust the pressure of the long fiber-reinforced thermoplastic even when the long fiber-reinforced thermoplastic is introduced into the second flow channel 220 while the continuous fiber-reinforced thermoplastic C is introduced into the first flow channel 210. Additionally, it is possible to effectively prevent the long fiber-reinforced thermoplastic from flowing backward along the second flow channel 220 or staying in the second flow channel 220 due to movement of the continuous fiber-reinforced thermoplastic C.

If the angle θ exceeds this range, increased pressure and friction caused by introduction of the long fiber-reinforced thermoplastic can hinder smooth movement of the continuous fiber-reinforced thermoplastic C.

In one embodiment, the first flow channel 210 may include a flow check gate 212 tapered at one end thereof.

Specifically, the flow check gate 212 may have an inner surface inclined at an angle of about 3° to about 8° toward a center thereof to be gradually decreased in inner diameter so as to increase friction between the outer circumference of the continuous fiber-reinforced thermoplastic and an inner wall of the first flow channel 210, making it difficult for the continuous fiber-reinforced thermoplastic to move in a reverse direction, thereby effectively preventing the continuous fiber-reinforced thermoplastic C from flowing backward due to the pressure of the long fiber-reinforced thermoplastic.

Furthermore, the flow check gate 212 can reduce the pressure load on the mold caused by introduction of the continuous fiber-reinforced thermoplastic C and can prevent the long fiber-reinforced thermoplastic from being broken due to excessive pressure when the long fiber-reinforced thermoplastic is joined with the continuous fiber-reinforced thermoplastic C after being introduced into the mold.

The first flow channel 210 may be provided on an outer circumference thereof with a first coolant line 211.

The first coolant line 211 is provided to prevent the temperature of the continuous fiber-reinforced thermoplastic from increasing due to friction and to stabilize an extrusion process after insertion of the continuous fiber-reinforced thermoplastic.

The mold is provided at one end thereof with a core 230 at which the first flow channel 210 and the second flow channel 220 are joined with each other.

The core 230 may be configured such that the long fiber-reinforced thermoplastic is introduced thereinto, bonded to the outer circumference of the continuous fiber-reinforced thermoplastic C, and formed into a hollow molded product through extrusion.

The core 230 has a structure enabling formation of a hollow molded product and provides a space in which the continuous fiber-reinforced thermoplastic and the long fiber-reinforced thermoplastic are fully melted and fused together.

For example, the core 230 may be a space extending by a distance of 15 mm to 50 mm from a distal end of the flow check gate 212 and, in this space, the long fiber-reinforced thermoplastic can be bonded and fused to the outer circumference of the continuous fiber-reinforced composite C.

An insert securing portion 240 may be disposed downstream of the core 230.

The insert securing portion 240 is provided to place the continuous fiber-reinforced thermoplastic C at a location where a molded product is subjected to a load to restrict movement of the continuous fiber-reinforced thermoplastic, thereby enabling formation and stabilization of a hollow molded product.

Placement of the continuous fiber-reinforced thermoplastic C within the molded product may be varied depending on the shape of the insert securing portion 240.

For example, the continuous fiber-reinforced thermoplastic C may be placed on the front and rear regions subjected to impact loads in the event of collision, thereby effectively enhancing the strength and stiffness of the molded product.

In one embodiment, the insert securing portion 240 may be provided on an outer circumference thereof with a second coolant line 241 surrounding the insert securing section 240.

With the second coolant line 241 disposed on the outer circumference of the insert securing portion 240, the long fiber-reinforced thermoplastic fused to the outer circumference of the continuous fiber-reinforced thermoplastic can be secondarily solidified, thereby preventing displacement of the continuous fiber-reinforced thermoplastic.

The extrusion unit 200 may be configured to bond the long fiber-reinforced thermoplastic to the continuous fiber-reinforced thermoplastic C fed from the unwinder 100, insert the continuous fiber-reinforced thermoplastic at a location where the molded product is subjected to impact loads in the event of collision, form a hollow molded product, and transfer the hollow molded product to the other side thereof.

The sizing unit 300 may cool the molded product transferred from the extrusion unit 200. More specifically, the sizing unit 300 may cool the extruded molded product by vacuum cooling.

It is preferable that the sizing unit 300 be continuously disposed immediately downstream of the extrusion unit 200 in which the molded product is formed.

The sizing unit 300 may assist in increasing the production rate of the molded product and securing the continuous fiber-reinforced thermoplastic C within the molded product.

The sizing unit 300 may be provided at an outer side thereof with a third coolant line 310 allowing the molded product to be introduced thereinto through one side thereof to cool the molded product.

With the third coolant line 310 provided to the sizing unit 300, it is possible to rapidly cool an interior of the sizing unit 300 while securing the continuous fiber-reinforced thermoplastic C in position.

The sizing unit 300 may be provided at one side thereof with a vacuum pump 320 to reduce the pressure inside the sizing unit, preferably, to create a near-vacuum environment inside the sizing unit.

As the vacuum pump 320 provided to the sizing unit 300 creates a near-vacuum environment inside the sizing unit 300, the molded product can be effectively cooled, thus facilitating securing of the continuous fiber-reinforced thermoplastic C while preventing fiber breakage.

The first puller 400 is disposed downstream of the sizing unit 300 to pull the molded product and continuously supply the molded product to the curvature forming unit 500.

Specifically, the first puller 400 is of a belt type and may control the pulling force exerted on the molded product by driving three or more rollers.

The curvature forming unit 500 may impart a predetermined curvature to the molded product. Specifically, the curvature forming unit 500 may impart a predetermined curvature to the molded product while cooling the molded product.

The curvature forming unit 500 may be provided on an outer side thereof with a coolant line (not shown).

With the coolant line disposed at the outer side of the curvature forming unit 500, it is possible to solidify the molded product to fix the curvature during the curvature forming process.

In one embodiment, the curvature forming unit 500 may include at least one curvature forming device arranged continuously to adjust the curvature of the molded product transferred from the first puller 400. For example, 4 to 8 sub-curvature forming devices may be arranged to impart a curvature to the molded product and gradually cool the molded product to fix the curvature.

With 4 to 8 sub-curvature forming devices arranged continuously, the curvature forming unit 500 can finely adjust the curvature of the molded product to prevent abrupt changes in curvature, which otherwise cause the continuous fiber-reinforced thermoplastic to be broken or exposed over the surface of the molded product.

The curvature forming unit 500 may impart a predetermined curvature to the molded product to manufacture a hollow molded product.

The second puller 600 may pull the molded product provided with the curvature in one direction.

The second puller 600 may convey and feed the molded product at a constant speed.

In typical extrusion processes utilizing a single puller to convey a molded product, the load of a curvature forming process can increase. In contrast, the present invention can effectively improve production efficiency through increase in manufacturing speed by increasing the feed rate of the molded product to the curvature forming unit 500 using the first puller 400 and pulling the molded product having passed through the curvature forming process using the second puller 600.

The cutting unit 700 may be disposed downstream of the second puller 600 to cut the molded product provided with the curvature.

The cutting unit 700 cuts the molded product provided with the curvature to manufacture a final hollow stiffener product provided with the curvature.

The stiffener manufacturing device 1000 includes the unwinder 100, the extrusion unit 200, the sizing unit 300, the first puller 400, the curvature forming unit 500, the second puller 600, and the cutting unit 700 arranged continuously to manufacture a stiffener product through a continuous process, thereby significantly improving the efficiency of stiffener manufacturing. Furthermore, the stiffener manufacturing device 1000 can prevent backflow of the continuous fiber-reinforced thermoplastic C during introduction thereof, can effectively prevent interfacial debonding of the long fiber-reinforced thermoplastic from the continuous fiber-reinforced thermoplastic C in prepreg form, can prevent the continuous fiber-reinforced thermoplastic C from being broken or exposed outside the stiffener, and can effectively enhance the overall strength and stiffness of the stiffener by placing the continuous fiber-reinforced thermoplastic C at a location in the stiffener where impact loads are concentrated.

Another aspect of the present invention relates to a stiffener manufacturing method.

FIG. 3 is a flowchart of a stiffener manufacturing method using the stiffener manufacturing device according to another aspect of the present invention.

Referring to FIG. 3, the stiffener manufacturing method includes: (a) unwinding a continuous fiber-reinforced thermoplastic in the form of two or more prepregs while adjusting tension of each of the prepregs;
(b) introducing the continuous fiber-reinforced thermoplastic into a first flow channel of a mold while introducing a long fiber-reinforced thermoplastic into a second flow channel of the mold, the second flow channel being formed at a different angle than the first flow channel, the first flow channel being provided at one end thereof with a flow check gate to prevent backflow of the continuous fiber-reinforced thermoplastic;
(c) introducing the long fiber-reinforced thermoplastic in a heated state into a core of the mold to bond the long fiber-reinforced thermoplastic to an outer circumference of the continuous fiber-reinforced thermoplastic;
(d) forming a molded product by securing the continuous fiber-reinforced thermoplastic in position at an insert securing portion disposed downstream of the core, followed by extrusion of the continuous fiber-reinforced thermoplastic together with the introduced long fiber-reinforced thermoplastic;
(e) sizing the molded product formed by extrusion under pressure while cooling the molded product;
(f) manufacturing a hollow stiffener by imparting a predetermined curvature to the molded product cooled in the step of sizing the molded product; and
(g) recovering the stiffener by cutting the molded product provided with the curvature.

Referring to FIG. 3, the stiffener manufacturing method relates to a method of manufacturing a hollow stiffener using the stiffener manufacturing device described above.

First, the continuous fiber-reinforced thermoplastic in the form of two or more prepregs is unwound while adjusting tension of each prepreg (S100).

Since the tension of each prepreg can be independently adjusted by adjusting the rotational speed of each bobbin of the unwinder, it is possible to prevent excessive tension from being applied to any one of the prepregs, which otherwise could cause a corresponding prepreg to be displaced from a designated position thereof within the molded product or to be exposed outside the molded product.

The continuous fiber-reinforced thermoplastic is introduced into the first flow channel of the mold while introducing the long fiber-reinforced thermoplastic into the second flow channel of the mold, which is formed at a different angle than the first flow channel, wherein the first flow channel is provided at one end thereof with a flow check gate to prevent backflow of the continuous fiber-reinforced thermoplastic (S200).

The long fiber-reinforced thermoplastic is introduced through the second flow channel. Here, in order to prevent backflow of the long fiber-reinforced thermoplastic caused by introduction of the continuous fiber-reinforced thermoplastic, the second flow channel allows the long fiber-reinforced thermoplastic to be introduced at an angle of 30° to 65° with respect to an extension direction of the first flow channel through which the continuous fiber-reinforced thermoplastic moves.

The flow check gate is disposed at one end of the first flow channel into which the continuous fiber-reinforced thermoplastic is introduced. Here, the flow check gate may be tapered to prevent the continuous fiber-reinforced thermoplastic from flowing backward along the first flow channel due to increased pressure caused by introduction of the long fiber-reinforced thermoplastic.

Since the continuous fiber-reinforced thermoplastic and the long fiber-reinforced thermoplastic are introduced into the mold at different angles through the first flow channel and the second flow channel, respectively, and the continuous fiber-reinforced thermoplastic is prevented from flowing backward, the long fiber-reinforced thermoplastic can be securely bonded and fused to the outer circumference of the continuous fiber-reinforced thermoplastic, thereby enabling manufacture of a molded product by extrusion.

At the core into which the long fiber-reinforced thermoplastic is introduced, the long fiber-reinforced thermoplastic in a heated state is introduced and bonded to the outer circumference of the continuous fiber-reinforced thermoplastic to form a composite (S300).

The long fiber-reinforced thermoplastic may be supplied to the second flow channel in pellet form.

The long fiber-reinforced thermoplastic may be plasticized and melted before being introduced and bonded to the outer circumference of the continuous fiber-reinforced thermoplastic to form a composite.

At the insert securing portion disposed downstream of the core, the continuous fiber-reinforced thermoplastic is secured in position and extruded together with the introduced long fiber-reinforced thermoplastic to form a molded product (S400).

In the step of manufacturing a molded product by securing the continuous fiber-reinforced thermoplastic in position at the insert securing portion, the continuous fiber-reinforced thermoplastic may be placed, for example, on the front and rear regions subjected to impact loads in the event of collision, thereby effectively enhancing the strength and stiffness of the molded product.

After the long fiber-reinforced thermoplastic is fused to the outer circumference of the continuous fiber-reinforced thermoplastic at the core, the continuous fiber-reinforced thermoplastic is introduced into the insert securing portion disposed downstream of the core to be cooled and secured in position and then extruded to form a molded product.

The molded product formed by extrusion under pressure is cooled and sized (S500).

For example, an insertion position of the continuous fiber-reinforced thermoplastic may be further stabilized through a sizing process involving cooling the molded product under near-vacuum pressure conditions.

A curvature is imparted to the molded product cooled in the step of sizing the molded product (S600).

After the step of sizing the molded product, the molded product passes through a curvature forming unit including multiple curvature forming devices to finely adjust the curvature thereof, thereby manufacturing a hollow stiffener provided with the curvature.

The molded product provided with the curvature is cut to recover the stiffener (S700).

A cutting unit is continuously disposed downstream of the curvature forming unit, thus enabling continuous production and recovery of the stiffener provided with the curvature.

Preferably, the continuous fiber-reinforced thermoplastic comprises two or more prepregs. Although the prepregs may be subjected to different tensions depending on the placement thereof within the molded product designated at the insert fixing portion, the tension of each prepreg can be independently adjusted by the unwinder including a plurality of bobbins in S100. Accordingly, it is possible to prevent excessive tension from being applied to one of the prepregs during the curvature forming process, which otherwise could cause a corresponding prepreg to be displaced or exposed outside the molded product. Furthermore, the curvature forming process can be stabilized and manufacturing efficiency can be increased by adjusting the pulling speed using the pullers disposed upstream and downstream of the curvature forming unit, whereby a final hollow stiffener product can be recovered through cutting of a continuous stiffener.

A further aspect of the present invention relates to a hollow stiffener for vehicles manufactured by the stiffener manufacturing method using the stiffener manufacturing device described above.

The hollow stiffener for vehicles includes a continuous fiber-reinforced thermoplastic disposed as a reinforcing material on front and rear regions thereof subjected to impact loads and has a constant curvature throughout the entirety thereof. In a static load test conducted using a UTM, static load performance of the hollow stiffener according to the present invention may be increased by 16% or more at a displacement of 30 mm and by 14% or more at a displacement of 40 mm, compared to that of a stiffener without the continuous fiber-reinforced thermoplastic.

Next, the present invention will be described in more detail with reference to some examples. However, it should be noted that these examples are provided for illustration only and are not to be construed in any way as limiting the present invention.

### Example 1

A continuous fiber-reinforced thermoplastic in the form of a prepreg impregnated with a polypropylene resin was prepared.

As the continuous fiber-reinforced thermoplastic, two prepregs were introduced into a mold of an extrusion unit through an unwinder.

The mold of the extrusion unit had a structure in which a first flow channel for passage of the continuous fiber-reinforced thermoplastic was separated from a second flow channel for passage of a long fiber-reinforced thermoplastic, wherein the angle between the first flow channel and the second flow channel was adjusted to 45°.

The continuous fiber reinforced composite was introduced into the mold through one side thereof, wherein tension of each prepreg was adjusted independently by adjusting the rotational speed of each bobbin of the unwinder to compensate for increase in tension of one prepreg placed outside relative to the other prepreg to maintain uniform tension across the prepregs, thereby preventing the corresponding prepreg from being displaced and exposed outside a stiffener during a curvature forming process.

A hollow stiffener was manufactured by performing extrusion while maintaining the mold at a temperature of 180° C. to 210° C. to plasticize the long fiber-reinforced thermoplastic. Since the continuous fiber-reinforced thermoplastic was in the form of a prepreg impregnated with a resin, bonding strength between the continuous fiber-reinforced thermoplastic and the long fiber-reinforced thermoplastic could be enhanced, thus preventing interfacial debonding of the continuous fiber-reinforced thermoplastic.

Specifically, the long fiber-reinforced thermoplastic was introduced into the second flow channel and then bonded to the outer circumference of the continuous fiber-reinforced thermoplastic, followed by extrusion, thereby manufacturing a molded product.

The molded product transferred from a first puller was allowed to pass through eight curvature forming devices, whereby the molded product was provided with a curvature while being gradually cooled to a temperature of 100° C. or less through introduction of coolant, thereby manufacturing a continuous hollow stiffener, which, in turn, was pulled by a second puller to be transferred to a cutting unit, where the stiffener was cut to a constant length, thereby manufacturing a final hollow stiffener for vehicles.

Experimental Example 1: Evaluation of static load performance of stiffener with varying placement of continuous fiber-reinforced thermoplastic.

To evaluate the strength and stiffness of a stiffener with varying placement of a continuous fiber-reinforced thermoplastic within the stiffener, structural analysis of static load performance was conducted by placing the continuous fiber-reinforced thermoplastic at various locations within the stiffener through a typical extrusion process.

LS-DYNA was employed for the structural analysis.

FIG. 4 shows results of structural analysis simulation of static load performance with varying placement of a reinforcing material within a stiffener.

Specifically, FIG. 4 presents measurement results of a static load value that each case of stiffeners can withstand at displacement of 30 mm and 40 mm, which define the strength required for automotive stiffeners. Although there were differences in the load value depending on the location of the continuous fiber-reinforced thermoplastic, it was confirmed that incorporation of the continuous fiber-reinforced thermoplastic led to increase in the static load value in all cases.

Based on the results of the structural analysis, optimal locations of the continuous fiber-reinforced thermoplastic were selected while considering feasibility in actual molding and reinforcement effects. It was confirmed that cases 5 and 6,where the continuous fiber-reinforced thermoplastic was placed at right/left sides of the stiffener in side sectional view, that is, the front and rear regions subjected to static loads, exhibited the highest reinforcement effect.

Experimental Example 2: Evaluation of static load performance of hollow stiffener for vehicles.

According to the procedure outlined in Example 1, stiffeners were manufactured with varying placement of the continuous fiber-reinforced thermoplastic.

A structural analysis of the manufactured stiffeners was conducted using LS-DYNA. Additionally, the properties of the continuous fiber-reinforced thermoplastic were obtained from tests conducted using a UTM (Quasar10, GALDABINI) in accordance with ASTM D3039.

First, each of the stiffeners manufactured according to the procedure outlined in Example 1 was secured to a support. The overall length of the stiffener was 1200 mm, and the distance between securing holes was 940 mm.

A static load test was conducted using a UTM (WL2100, Withlab Co., Ltd.) to measure the load that the stiffener could withstand when compressed at the center thereof at a speed of 50 mm/min.

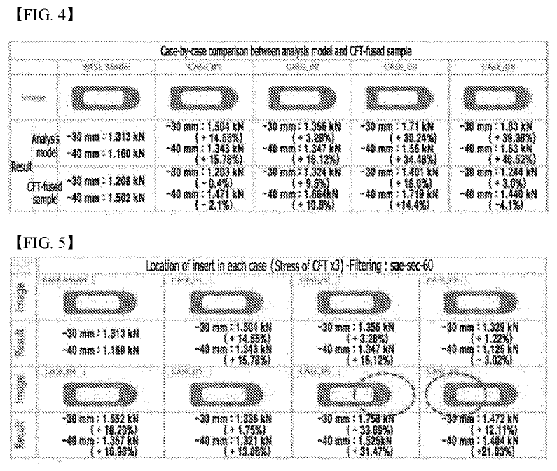

FIG. 5 shows measurement results of static load performance of a stiffener according to one embodiment of the present invention and measurement results of static load performance depending on the location of a reinforcement material.

A comparative evaluation was conducted between results of a simulated analysis performed by placing and fusing the continuous fiber-reinforced thermoplastic at various locations within the stiffener to a level achievable in actual molding and results of measuring the performance of an actual stiffener product.

An actual increase in static load performance exhibited a tendency to decrease compared to the results of the simulated analysis, depending on the moldability of each insertion region. However, in case 3, where the continuous fiber-reinforced thermoplastic was placed on the front and rear regions subjected to static loads, static load performance of the stiffener was increased by 16% at a displacement of 30 mm and by 14% at a displacement of 40 mm, compared to the case without the continuous fiber-reinforced thermoplastic.

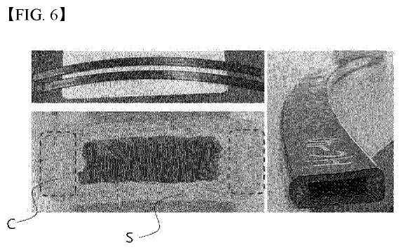

FIG. 6 is a photograph of a hollow stiffener manufactured by the stiffener manufacturing method according to the present invention.

Referring to FIG. 6, the hollow stiffener S was provided with a curvature and included a continuous fiber-reinforced thermoplastics C securely inserted in both front and rear regions thereof. In addition, it was confirmed that no interfacial delamination occurred and that the continuous fiber-reinforced thermoplastic C conformed to the curvature and was not exposed outside the stiffener.

Therefore, the present invention has identified the most effective structural location for placing the continuous fiber-reinforced thermoplastic within a hollow stiffener with a narrow cross-section to enhance the stiffness and strength of the hollow stiffener. Furthermore, the present invention provides a newly designed stiffener manufacturing device that can manufacture a stiffener for vehicles with enhanced strength and stiffness by securely inserting a continuous fiber-reinforced thermoplastics in the form of at least two prepregs within the stiffener while preventing the continuous fiber-reinforced thermoplastic from being exposed outside the stiffer due to excessive tension during a curvature forming process and preventing the long fiber-reinforced thermoplastic from being broken.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications.

1. A stiffener manufacturing device comprising:
an unwinder unwinding and continuously supplying a continuous fiber-reinforced thermoplastic (CFT);
an extrusion unit disposed at one side of the unwinder and comprising a mold in which a long fiber-reinforced thermoplastic (LFT) is bonded to an outer circumference of the continuous fiber-reinforced thermoplastic, the mold comprising a first flow channel into which the continuous fiber-reinforced thermoplastic is introduced and a second flow channel into which the long fiber-reinforced thermoplastic is introduced at a different angle than the continuous fiber-reinforced thermoplastic;
a sizing unit cooling a molded product discharged from the extrusion unit;
a first puller disposed downstream of the sizing unit and adjusting tension of the continuous fiber-reinforced thermoplastic;
a curvature forming unit imparting a predetermined curvature to the molded product while cooling the molded product;
a second puller pulling the molded product provided with the curvature; and
a cutting unit disposed downstream of the second puller to cut the molded product provided with the curvature.

2. The stiffener manufacturing device according to claim 1, wherein the second flow channel is tilted at an angle of 30° to 65° with respect to an extension direction of the first flow channel.

3. The stiffener manufacturing device according to claim 1, wherein the first flow channel comprises a flow check gate tapered at one end thereof.

4. The stiffener manufacturing device according to claims 1, wherein the first flow channel is provided on an outer circumference thereof with a first coolant line.

5. The stiffener manufacturing device according to claim 1, wherein the mold further comprises a core at which the first flow channel is joined with the second flow channel and in which the long fiber-reinforced thermoplastic is continuously introduced to the outer circumference of the continuous fiber-reinforced thermoplastic to form the molded product.

6. The stiffener manufacturing device according to claim 5, wherein an insert securing portion is disposed downstream of the core.

7. The stiffener manufacturing device according to claim 5, wherein the insert securing portion is provided on an outer circumference thereof with a second coolant line surrounding the insert securing portion.

8. The stiffener manufacturing device according to claim 1, wherein the sizing unit comprises a third coolant line cooling the molded product and a vacuum pump disposed at one side thereof.

9. The stiffener manufacturing device according to claim 1, wherein the continuous fiber-reinforced thermoplastic comprises at least two prepregs.

10. The stiffener manufacturing device according to claim 1, the unwinder adjusts tension of each prepreg introduced into the mold.

11. The stiffener manufacturing device according to claim 1, wherein the curvature forming unit comprises one or more curvature forming devices arranged continuously to adjust the curvature of the molded product transferred from the first puller.

12. A stiffener manufacturing method comprising:
(a) unwinding a continuous fiber-reinforced thermoplastic in the form of two or more prepregs while adjusting tension of each of the prepregs;
(b) introducing the continuous fiber-reinforced thermoplastic into a first flow channel of a mold while introducing a long fiber-reinforced thermoplastic into a second flow channel of the mold, the second flow channel being formed at a different angle than the first flow channel, the first flow channel being provided at one end thereof with a flow check gate to prevent backflow of the continuous fiber-reinforced thermoplastic;
(c) introducing the long fiber-reinforced thermoplastic in a heated state into a core of the mold to bond the long fiber-reinforced thermoplastic to an outer circumference of the continuous fiber-reinforced thermoplastic;
(d) forming a molded product by securing the continuous fiber-reinforced thermoplastic in position at an insert securing portion disposed downstream of the core, followed by extrusion of the continuous fiber-reinforced thermoplastic together with the introduced long fiber-reinforced thermoplastic;
(e) sizing the molded product formed by extrusion under pressure while cooling the molded product;
(f) manufacturing a hollow stiffener by imparting a predetermined curvature to the molded product cooled in the step of sizing the molded product; and
(g) recovering the stiffener by cutting the molded product provided with the curvature.

13. A hollow stiffener for vehicles manufactured by the stiffener manufacturing method according to claim 12.
